(19) United States
(12) Patent Application Publication
(10) Pub. No.: US 2024/0211214 A1
(43) Pub. Date: Jun. 27, 2024

(54) TRNG Conditioning Component with Extended Output Capability

(71) Applicant: SK hynix Inc., Gyeonggi-do (KR)

(72) Inventors: Alexander Ivaniuk, Minsk (BY); Siarhei Zalivaka, Minsk (BY)

(21) Appl. No.: 18/089,370

(22) Filed: Dec. 27, 2022

(51) Int. Cl. G06F 7/58

(52) U.S. Cl. CPC G06F 7/588; G06F 2207/581

(57) ABSTRACT

A random number generator and method for generating random numbers. The random number generator has a noise source configured to generate N sources of N noise bits and has a conditioning component comprising a multiple input exclusive-OR circuit generating feedback bits and a multiple input shift register receiving the feedback bits. The conditioning component is configured to process a sequence of the N noise bits from the N noise sources and output M random bits including the feedback bits obtained as a result of pre-computing.

### BACKGROUND

### 1. Field

Embodiments of the present disclosure relate to a random number generation.

### 2. Description of the Related Art

A common scheme for a National Institute of Standards and Technology (NIST) certified true random number generator (TRNG) consists of an entropy source, a conditioning component, and health tests unit. Together these components can generate sequences of true random numbers with targeted statistical characteristics. The entropy source model itself consists of a noise source and a digitalization scheme (in the case of analog noise). The conditioning component is responsible for reducing bias and/or increasing the entropy rate of the resulting output bits. If the initial noise source provides insufficient entropy, additional post-processing schemes can be used. For example, Von Neumann Corrector, exclusive ORing (XORing), and linear feedback shift registers (LFSR) schemes are widely used for digital noise improvement.

XORing schemes have been used in case of forming an entropy single bit channel (N=1) from several (N) noise sources. A multiple bit (L-bit) LFSR is used to compress the sequences of bits from a single (N=1) noise source to form M (1≤M≤L) output random bits. This approach generates an acceptable entropy for the conditioning component, but it has a low bandwidth because of a single bit channel.

The generation of random numbers also has used two modes. In mode 1, LFSR is configured as MISR (Multiple Input Shift Register) which compresses symbols from N noise sources into the M-bit random numbers (in this case M=N). This configuration has an acceptable bandwidth, but produces a low quality of generated sequences of random numbers. In mode 2, N LFSRs are used as SISRs (Single Input Shift Registers) to compress N noise sources simultaneously into the M-bit random number (M=N). This approach speeds-up the performance of the whole entropy source and has a higher quality of the output random number sequence (as compared to mode 1) but can increase hardware overhead which may not be acceptable for various applications.

### SUMMARY

In one embodiment of the present invention, there is provided a random number generator having a noise source configured to generate N sources of N noise bits and a conditioning component having a multiple input exclusive-OR circuit generating feedback bits and a multiple input shift register receiving the feedback bits. The conditioning component is configured to process a sequence of the N noise bits from the N noise sources and output M random bits including the feedback bits.

In one embodiment of the present invention, there is provided a method for generating a random number sequence. The method inputs N noise bits from the N noise sources into a conditioning component having an exclusive-OR circuit and a multiple input shift register, shifts values of bits in an initial state in the multiple input shift register to an adjacent bit position, generates feedback bits from the exclusive-OR circuit, inserts the feedback bits into bit positions; and outputs M random bits including the feedback bits.

Additional aspects of the present invention will become apparent from the following description.

### BRIEF DESCRIPTION OF THE DRAWINGS

FIG. 1 is a block diagram of an entropy source in accordance with one embodiment of the present invention;

FIG. 2 is a block diagram of a linear feedback shift register (LFSR) in accordance with one embodiment of the present invention;

FIG. 3 is a linear feedback shift register (LFSR) circuit diagram in accordance with still another embodiment of the present invention;

FIG. 4 is a block diagram of a single input shift register (SISR) in accordance with still another embodiment of the present invention;

FIG. 5 is a circuit diagram of the SISR block diagram of FIG. 4.

FIG. 6 is a block diagram of multiple SISR registers acting as a conditioning component in accordance with yet a further embodiment of the present invention;

FIG. 7 is a block diagram of a multiple input shift register (MISR) in accordance with a still further embodiment of the present invention;

FIG. 8 is a circuit diagram of MISR circuit in accordance with one embodiment of the present invention;

FIG. 9 is a circuit diagram of an initial state of M-bit SISR circuit in accordance with another embodiment of the present invention;

FIG. 10 is a block diagram of computing two states of a SISR in time;

FIG. 11A is a block diagram of computing two states of SISR in space;

FIG. 11B is a circuit diagram of a SISR circuit after one round of pre-computing;

FIG. 12 is a block diagram of computing M states of SISR in space;

FIG. 13 is a circuit diagram of a SISR circuit after M rounds of pre-computing;

FIG. 14 is a circuit diagram of 4-bit SISR circuit after 4 rounds of pre-computing;

FIG. 15 is a graph of output entropy values depending on the number of pre-computed steps; and

FIG. 16 is a flowchart illustrating a method for generating a random number sequence in accordance with yet another embodiment of the present invention.

### DETAILED DESCRIPTION

Various embodiments are described below in more detail with reference to the accompanying drawings. The present invention may, however, be embodied in different forms and thus should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrase are not necessarily to the same embodiment(s). Throughout the disclosure, like reference numerals refer to like parts in the figures and embodiments of the present invention.

The invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims. The invention encompasses numerous alternatives, modifications and equivalents within the scope of the claims. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

In one embodiment of the invention, an inventive random number generation technique utilizing conditioning component(s) with high performance is provided which generates multiple output random bits with acceptable statistical characteristics and has an acceptable hardware overhead. Also, in one embodiment of the invention, while supporting health tests for each channel of the noise source (a NIST standard) brings an additional hardware overhead for multi-bit output of entropy source, the inventive random number generation technique provides a greater output capacity for the entropy source while the number of channels in the noise source is kept small.

In one embodiment of the invention, the conditioning component is based on a single input shift register (SISR) circuit which significantly extends the capacity of a noise source. Assume that a noise source has N elements and generates N bits and sequentially sends each bit to the SISR component with M-bit output (M>N) and cyclically repeats each N bits to fit the output capacity. If M<N, the SISR component can be extended to the N-bit one to make M=N. For example, the SISR component can be extended by adding extra M-N flip-flops plus extra XOR elements corresponding to feedback polynomial with degree of M. This SISR component operates M clock cycles in order to provide the required number of output bits (M). In one embodiment of the invention, the performance overhead of M clock cycles can be significantly reduced by pre-computing each of M rounds.

In one embodiment of the invention, one round of the SISR component has two steps: a) XORing internal state output bits according to a feedback polynomial with a single input bit in order to generate a feedback bit; and b) shifting the register by one position in order to add the generated feedback bit to the internal register,

Each round adds extra XOR gates into the data path in order to compute an additional bit before shifting the register. Assume that each step requires w XOR gates, as a result, avoiding M steps of SISR brings additional (w×M) XOR gates to the hardware overhead for pre-computing feedback bits for each round. The exact value of w may vary depending on feedback polynomial and the total number of (w×M) gates can be logically optimized. On the other hand, each channel of noise source requires compulsory health tests which occupy extra h gates (h>>w). Thus, the architecture saves (M−N)×h gates compared to a conventional M-input multiple input shift register (MISR) component which requires M independent inputs from noise source. This architecture also requires fewer hardware resources compared to M SISR components having a comparable entropy score.

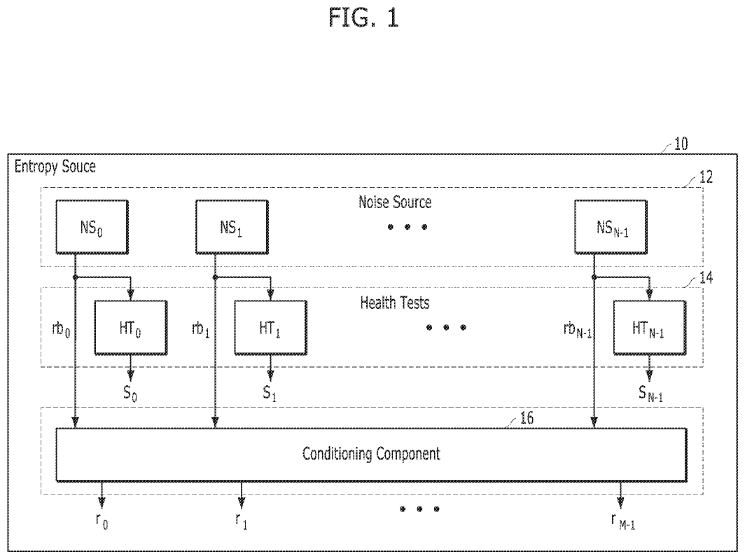

A general block diagram of an M-output entropy source 10 containing three basic components (noise source 12, health tests 14, conditioning component 16) is shown in FIG. 1. The entropy source 10 shown in FIG. 1 has N independent noise sources (NSi, 0≤i≤N−1) followed by N health tests blocks (HTi, 0≤i≤N−1) and a conditioning component 16. Each NSi produces random bits rbi which are fed into a corresponding HTi block indicating the status of the NSi (Si=0−entropy is below than expected, Si=1−entropy is as expected or higher). Random bits are processed by the conditioning component 16 in order to achieve better statistical characteristics of the processed sequences on outputs of r0, r1, . . . , rM−1.

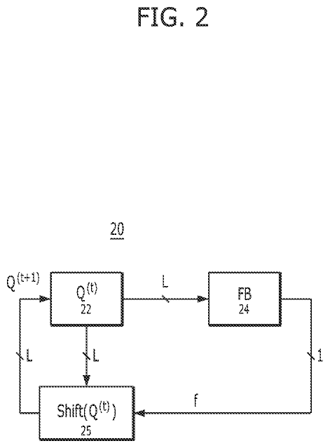

While the conditioning component 16 presented herein is linear feedback shift register (LFSR) based, the invention is not so limited and other conditioning components may be used. For example: Von Neumann corrector, hash or encryption algorithms etc. An LFSR 20 is schematically represented in the block diagram of FIG. 2.

Basically, LFSR 20 has a multiple bit (L-bit) register 22 for storing current state Q(t)={q0(t), q1(t), . . . , qL−1(t)} at the moment of time t. LFSR 20 has a feedback block FB 24 which generates an additional feedback bit f based on state Q(t) and feedback polynomial φ(0)=⊕ᵢ₌₀^{L-1}αᵢ·qᵢ+1 as shown in equation (1).

$$f = {⊕}_{i = 0}^{L - 1} {α}_{i} \cdot {q}_{i}^{( t )} , \qquad ( 1 )$$

where αᵢ is a polynomial coefficient which can be either 0 or 1. LFSR 20 has a shifting component 25 in the feedback loop to register 22.

The number of inputs of the feedback XOR gate depends on the number of K non-zero αᵢ values. As a result, K values are taken from the outputs of at least two of the current states and XORed in order to get feedback bit f. Thus, after computations, the next state of LFSR 20 is Q(t+1)={f, q0(t), q1(t), . . . , qL−2(t)}, which represents a right-shift in bit data with a replacement bit (the feedback bit) being inserted for the starting bit value.

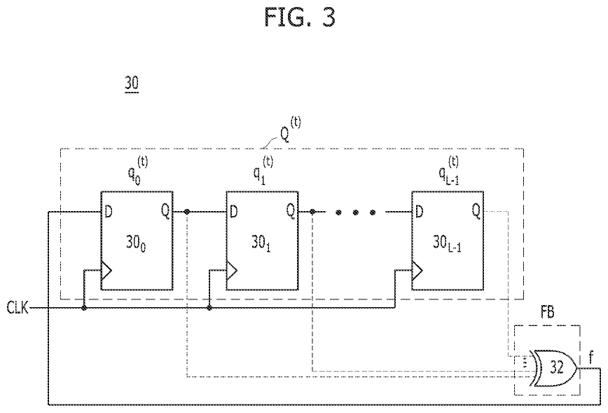

The block diagram of FIG. 2 can be implemented as shown in the circuit diagram of FIG. 3 where each flip flop 30₀, 30₁, . . . 30_{L-1} comprises a linear feedback shift register receiving a clock input to trigger bit shifting to the right, and with flip flop 30₀ receiving a feedback bit f from the output of a multiple input exclusive OR gate 32 to replace the bit value stored in flip flop 30₀.

In the invention, there are at least three embodiments of conditioning component 16.

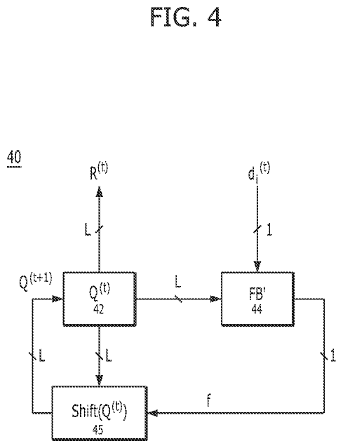

Embodiment 1. SISR 40 in FIG. 4 is used as a conditioning component 16 and has a single data input di(t) (0≤i≤N−1) at the moment of time t, the data input being compressed by a linear feedback shift register with internal states Q(t)={q0(t), q1(t), . . . , qL−1(t)} (N<L). Here, compression means obtaining the compact characteristic of the input data. Such compression may be lossy. The block diagram of the SISR circuit is shown in FIG. 4. Similar to FIG. 2, SISR 40 has a register 42 for storing current state Q(t)={q0(t), q1(t), . . . , qL−1(t)} at the moment of time t and has a feedback block FB′ 44 which generates an additional feedback bit f based on state Q(t) and the feedback polynomial φ(Q). SISR 40 has a shifting component 45 in the feedback loop to register 42.

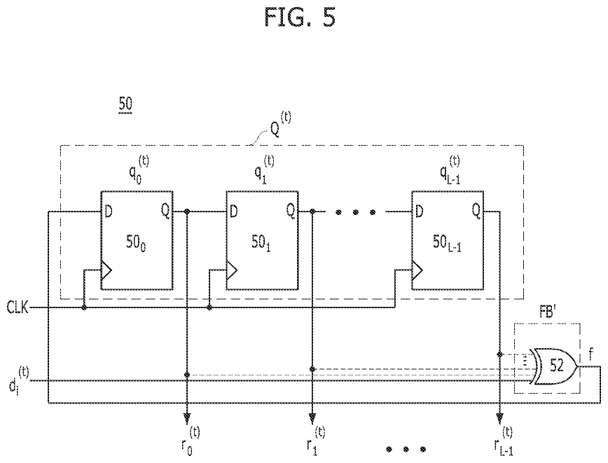

This block diagram in FIG. 4 can be implemented on a gate level as shown in the circuit diagram of FIG. 5. In this embodiment, a feedback bit f is generated in a similar way as in LFSR circuit 30 but with additional (XOR) operation on the input bit di(t). The SISR circuit 50 can output from 1 to L bits from R(t)={r0(t), r1(t), . . . , rL−1(t)}=Q(t), but usually only one bit from R(t) is used as a conditioned single bit random value. In the circuit diagram of FIG. 5, flip flops 50₀, 50₁, . . . 50_{L-1} comprise a linear feedback shift register which receives a clock input to trigger bit shifting to the right, with flip flop 50₀ receiving a feedback bit f from the output of a multiple input exclusive OR gate 52 to replace the bit value stored in flip flop 50₀, and each flip flop 50₀, 50₁, . . . 50_{L-1} outputting a sequence of random bits r₀, r₁, . . . r_{L-1}.

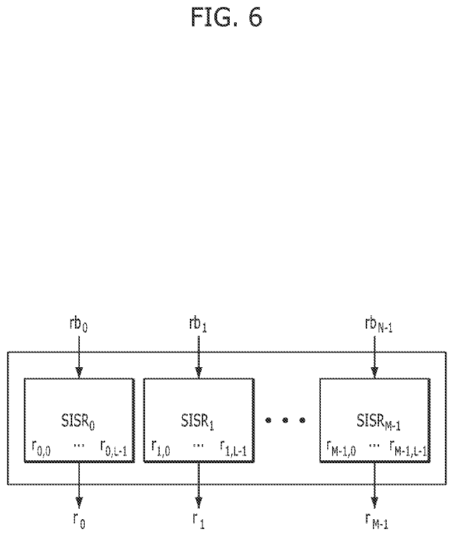

Since the conditioning component requires N inputs D(t)={d0(t), d1(t), . . . , dN−1(t)} and M outputs R(t)={r0(t), r1(t), . . . , rM−1(t)} (M=N) and since the SISR circuit 50 has only one effective output for each input noise bit, in one embodiment of the invention, M SISR circuits are replicated in order to provide M independently generated bits r0(t), r1(t), . . . , rM−1(t), as shown in FIG. 6, where SISR circuits SISR₀, SISR₁, . . . , SISR_{M-1} are shown receiving inputs rb₀, rb₁, . . . rb_{N-1}, and outputting a sequence of random bits r₀, r₁, . . . r_{M-1}.

In this embodiment of the invention, the conditioning component 16 is based on M blocks implementing L-bit SISRs (L≥N). Since each SISR has a single-bit data input, the output is also one-bit to provide better statistical characteristics of the generated sequence. The output bit can be chosen from any one of the flip-flops (e.g., from the last flip flop 50_{L-1}). For example, if SISRi has {ri,0, ri,1, . . . , ri,L−1} outputs, ri,_{L-1} can be chosen as an output bit ri.

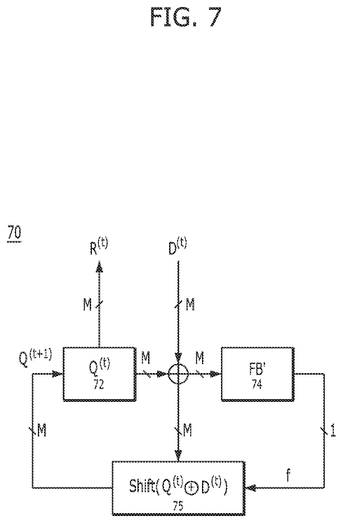

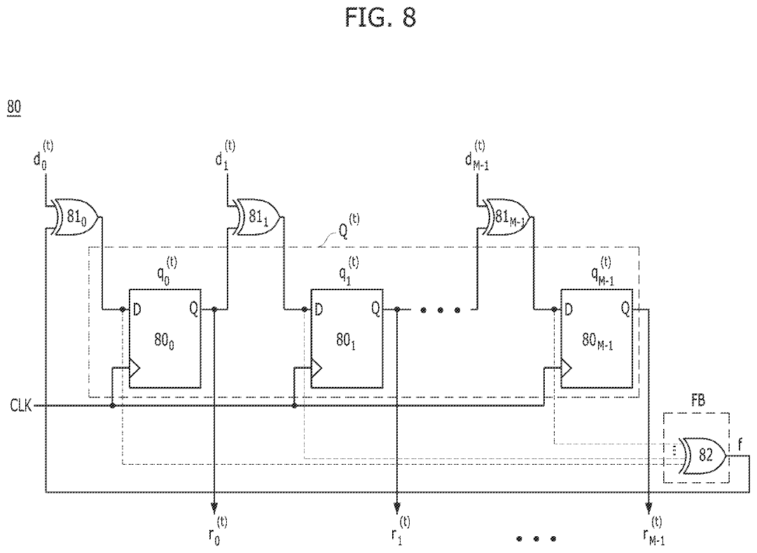

Embodiment 2. FIG. 7 is a MISR block diagram of a multiple input shift register MISR 70, and FIG. 8 is a circuit diagram of the MISR circuit 80. As shown in FIG. 7, MISR 70 used as a conditioning component 16 has multiple data inputs D(t). Similar to FIG. 2, MISR 70 has a) a register 72 for storing current state Q(t)={q0(t), q1(t), . . . , qL−1(t)} at the moment of time t and b) a feedback block FB 74 which generates an additional bit f based on state Q(t) and a feedback polynomial. MISR 70 has a shifting component 75 in the feedback loop to register 72. In particular, as shown in FIG. 8, MISR circuit 80 has M (M=N=L) input channels for D(t)={d0(t), d1(t), . . . , dM−1(t)}, M flip-flops 80₀, 80₁, . . . 80_{M-1} to store the internal state Q(t)={q0(t), q1(t), . . . , qM−1(t)}, M two-input XOR gates 81₀, 81₁, . . . 81_{M-1} to add input data to the internal state values. In the circuit diagram of FIG. 8, flip flops 80₀, 80₁, . . . 80_{M-1} comprise a linear feedback shift register receiving a clock input to trigger bit shifting to the right, with flip flop 80₀ receiving a feedback bit f from the output of an multiple input exclusive OR gate 82. Each flip flop 80₀, 80₁, . . . 80_{M-1} outputs a sequence of random bits r₀, r₁, . . . r_{M-1}. The M-bit MISR circuit 80 meets the conditioning component 16 requirement of M inputs D(t)={d0(t), d1(t), . . . , dM−1(t)} and M outputs R(t)={r0(t), r1(t), . . . , rM−1(t)}.

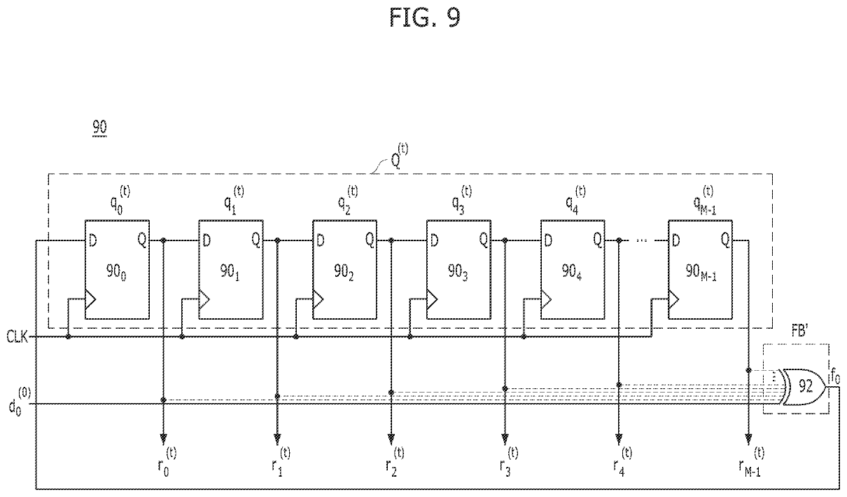

Embodiment 3. In one embodiment of the invention, the conditioning component 16 combines principles of the SISR and extends the output capacity similarly to the MISR in order to provide a higher quality of generated random number sequence(s) within one clock cycle. In one embodiment of the invention, this hybrid circuit has only N<M effective inputs which are cyclically repeated to fill the M-input structure. This embodiment is based on the M-bit SISR which output is pre-computed for M sequentially fed input values d0, d1, . . . , dN−1, d0, d1, . . . , dN−1, d0, d1, . . . , dN−1, . . . . This pre-computation is illustrated FIGS. 9-13 and shown below.

The initial state of the M-bit SISR circuit 90 is shown in FIG. 9. This circuit corresponds to the operational principles of the general SISR circuit (described above with respect to FIG. 4). In the circuit diagram of FIG. 9, each flip flop 90₀, 90₁, . . . 90_{M-1} receives a clock input to trigger bit shifting to the right, with flip flop 90₀ receiving a feedback bit f from the output of a multiple input exclusive OR gate 92, and each flip flop 90₀, 90₁, . . . 90_{M-1} outputs a sequence of random bits r₀, r₁, . . . r_{M-1}.

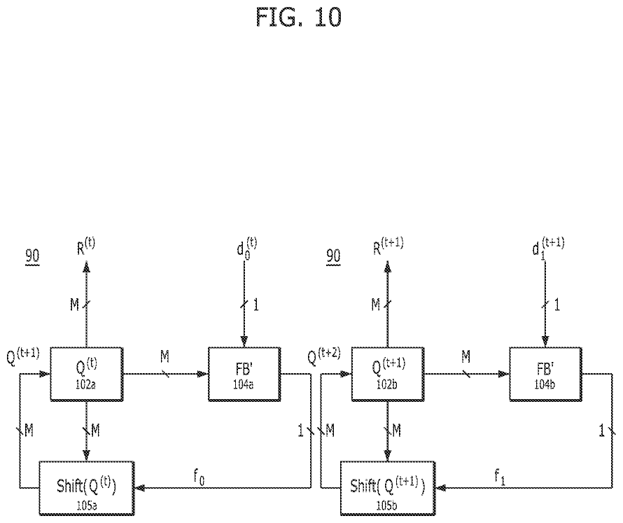

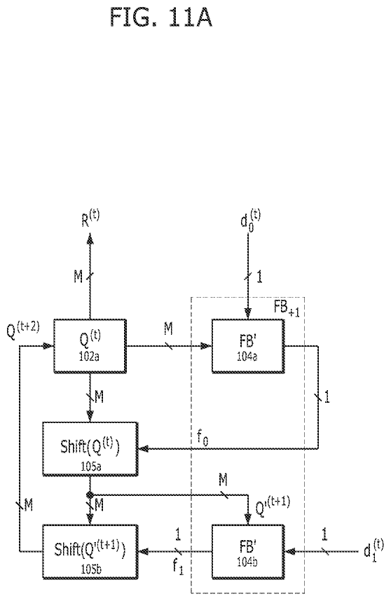

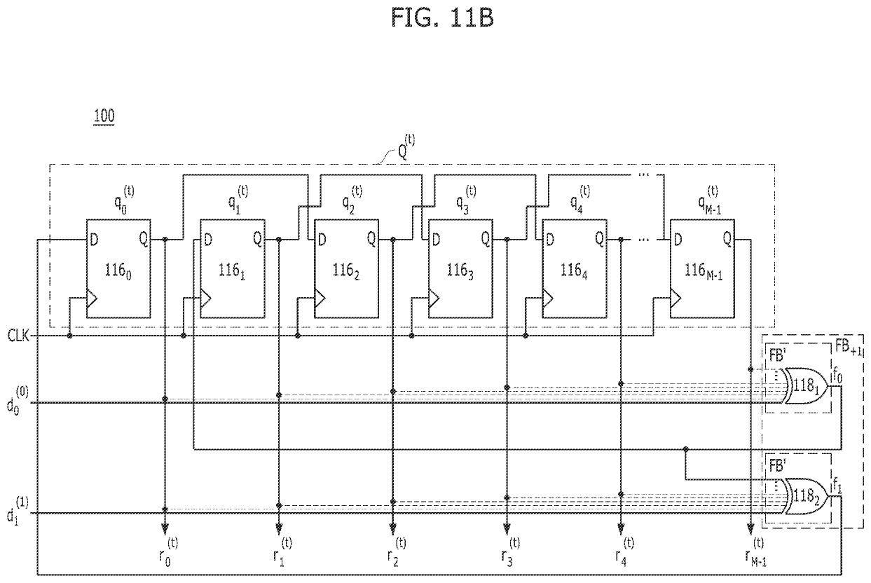

To compute the next state of SISR Q(t+2) based on the current state Q(t) and inputs d0(t) and d1(t+1), the feedback function is computed twice as shown in the block diagram of FIG. 10, where linear feedback shift registers 102a and 102b are respectively paired with feedback blocks 104a and 104b to provide two values of feedback bit f computed in two moments of time t and t+1 respectively. Here, as shown in FIG. 10, each MISR 90 has a shifting component (105a or 105b) in the feedback loop to register 102a or 102b. The computations shown in FIG. 10 require two clock cycles, which can be performed within one cycle by combining feedback functions as shown in FIG. 11A. In this case, inputs d0(t) and d1(t) are submitted at the same moment of time t, and the temporary state Q′(t+1) is precomputed by the output from feedback block 104a.

The computations required to generate this circuit are presented below.

Consider the initial internal state values Q(0)={q0(0), q1(0), . . . , qM−1(0)} and the feedback bit f0 computed based on equation (1) (see XOR gate 118; in FIG. 11B providing a feedback bit f0 to the second flip-flop in the linear feedback shift register, that is to flip-flop 116₁). The internal flip-flop values for the next round can be computed as follows (where ⊕ is the bit-wise exclusive OR operation):

$$\\ \begin{matrix}\begin{matrix}{q}_{0}^{{}_{} ( 1 )} = {f}_{0} ⊕ {d}_{0}^{{}_{} ( 0 )} , \\ {q}_{1}^{{}_{} ( 1 )} = {q}_{0}^{{}_{} ( 0 )} , \\ ⋯ \\ {q}_{N - 1}^{{}_{} ( 1 )} = {q}_{N - 2}^{{}_{} ( 0 )} , \\ \\ {q}_{N}^{{}_{} ( 1 )} = {q}_{N - 1}^{{}_{} ( 0 )} , \\ ⋯ \\ {q}_{M - 1}^{{}_{} ( 1 )} = {q}_{M - 2}^{{}_{} ( 0 )} .\end{matrix} & ( 2 )\end{matrix}$$

New feedback value f1 can also be computed in accordance with equation (1) using values Q(1)={f0, q0(0), q1(0), . . . , qM−2(0)}. This process utilizes an additional (K+1)-input XOR gate to the hardware overhead (see XOR gate 118₂ in FIG. 11B providing a feedback bit f1 to the first flip-flop in the linear feedback shift register, that is to flip-flop 116₀).

The modified SISR circuit 100 with one precomputation is shown in FIG. 11B. In the circuit diagram of FIG. 11B, flip flops 116₀, 116₁, . . . 116_{M-1} comprise a linear feedback shift register, with the flip-flops receiving a clock input to trigger bit shifting to the right, with flip flop 116₀ receiving a feedback bit f1 from the output of a multiple input exclusive OR gate 118₂, with flip flop 116₁ receiving a feedback bit f0 from the output of a multiple input exclusive OR gate 118₁ and each flip flop 116₀, 116₁, . . . 116_{M-1} outputs a sequence of random bits r₀, r₁, . . . r_{M-1}.

In the next round of modified SISR circuit 100, internal states are recomputed as follows:

$$\\ \begin{matrix}\begin{matrix}{q}_{0}^{{}_{} ( 2 )} = {f}_{1} ⊕ {d}_{1}^{{}_{} ( 1 )} \\ \\ {q}_{1}^{{}_{} ( 2 )} = {q}_{0}^{{}_{} ( 1 )} = {f}_{0} \\ {q}_{2}^{{}_{} ( 2 )} = {q}_{1}^{{}_{} ( 1 )} = {q}_{0}^{{}_{} ( 0 )} \\ ⋯ \\ {q}_{N - 1}^{{}_{} ( 2 )} = {q}_{N - 2}^{{}_{} ( 1 )} = {q}_{N - 3}^{{}_{} ( 0 )} \\ \\ {q}_{N}^{{}_{} ( 2 )} = {q}_{N - 1}^{{}_{} ( 1 )} = {q}_{N - 2}^{{}_{} ( 0 )} \\ ⋯ \\ {q}_{M - 1}^{{}_{} ( 2 )} = {q}_{M - 2}^{{}_{} ( 1 )} = {q}_{M - 3}^{{}_{} ( 0 )}\end{matrix} & ( 3 )\end{matrix}$$

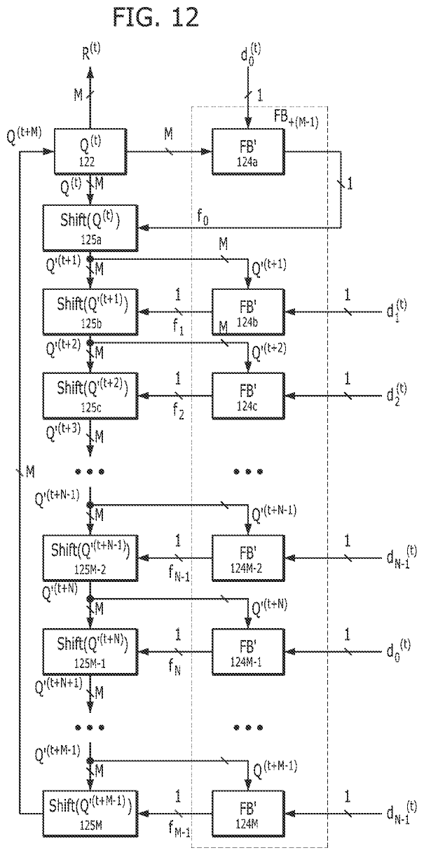

In one embodiment of the invention, the process described above can be generalized on M steps to compute values of feedback bit f2, f3, . . . , fM−1. In this case, the block diagram of a SISR with M pre-computed steps is shown in FIG. 12, where shift register 122 provides input to feedback blocks 124a, 124b, 124c, . . . 124M. Here, as shown in FIG. 12, shifting components 125a, 125b . . . 125M receive respective feedbacks from feedback blocks 124a, 124b, 124c, . . . 124M. output to downstream feedback blocks.

This SISR with M pre-computed steps may use all inputs D(t)={d0(t), d1(t), . . . , dN−1(t), d1(t) . . . , dN−1(t)} at the moment of time t and may pre-compute temporary states Q′(t+1), . . . , Q′(t+M−1) in order to generate final state Q′(t+M). M inputs (M>N) are required to improve the quality of generated random sequences as every flip-flop in the shift register should be updated using feedback computation. A smaller number of pre-computed rounds may lead to worse statistical characteristics but with lower hardware overhead.

As a result, after M SISR rounds, M feedback bits are computed as follows:

$$\\ \begin{matrix}\begin{matrix}{f}_{0} = ( {⊕}_{i = 0}^{M - 1} {α}_{i} \cdot {q}_{i}^{{}_{} ( 0 )} ) ⊕ {d}_{0}^{{}_{} ( 0 )} , \\ {f}_{1} = ( {⊕}_{i = 1}^{M - 1} {α}_{i} \cdot {q}_{i - 1}^{{}_{} ( 0 )} ) ⊕ {d}_{1}^{{}_{} ( 1 )} ⊕ ( {α}_{0} \cdot {f}_{0} ) , \\ {f}_{2} = ( {⊕}_{i = 2}^{M - 1} {α}_{i} \cdot {q}_{i - 2}^{{}_{} ( 0 )} ) ⊕ {d}_{2}^{{}_{} ( 2 )} ⊕ ( {α}_{1} \cdot {f}_{0} ) ⊕ ( {α}_{0} \cdot {f}_{1} ) , \\ ⋯ \\ {f}_{N - 1} = ( {⊕}_{j = 0}^{N - 1} {α}_{j} \cdot {f}_{N - 1 - j} ) ⊕ ( {⊕}_{i = N}^{M - 1} {α}_{i} \cdot {q}_{i - N}^{{}_{} ( 0 )} ) ⊕ {d}_{N - 1}^{{}_{} ( N - 1 )} , \\ \\ {f}_{N} = ( {⊕}_{j = 0}^{N} {α}_{j} \cdot {f}_{N - j} ) ⊕ ( {⊕}_{i = N + 1}^{M - 1} {α}_{i} \cdot {q}_{i - N - 1}^{{}_{} ( 0 )} ) ⊕ {d}_{0}^{{}_{} ( N )} , \\ ⋯ \\ {f}_{M - 1} = ( {⊕}_{j = 0}^{M - 2} {α}_{j} \cdot {f}_{M - 2 - j} ) ⊕ ( {α}_{M - 1} \cdot {q}_{0}^{{}_{} ( 0 )} ) ⊕ {d}_{N - 1}^{{}_{} ( M - 1 )} , \\ {f}_{0} is updating {q}_{M - 1}^{{}_{} ( 0 )} flip ‐ flop state , {f}_{1} - {q}_{M - 2}^{{}_{} ( 0 )} , … , {f}_{M - 1} - {q}_{0}^{{}_{} ( 0 )} .\end{matrix} & ( 4 )\end{matrix}$$

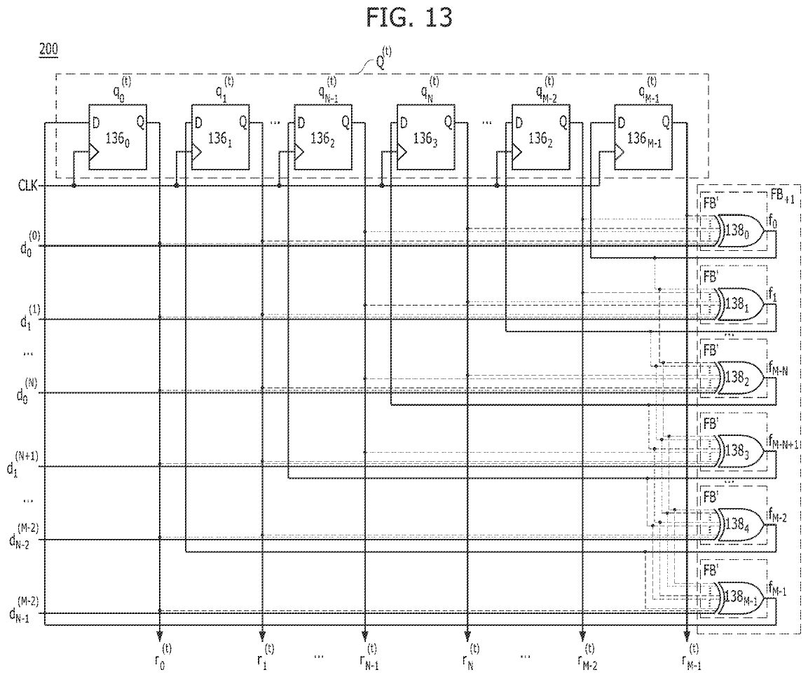

The resultant pre-computing circuit 200 is shown in FIG. 13. In the circuit diagram of FIG. 13, each flip flop 136₀, 136₁, . . . 136_{M-1} receives feedback bits f0, f1, f2, . . . , fM−1 from respective outputs of multiple input exclusive OR gates 138₀, 138₁, . . . 138_{M-1}. Each flip flop 136₀, 136₁, . . . 136_{M-1} outputs a sequence of random bits r₀, r₁, . . . r_{M-1}.

As a result, a SISR circuit is transformed to the M-input M-output pre-computing circuit which in the worst case adds extra M (K+1)-input XOR gates (that are multiple input exclusive OR gates 138₀, 138₁, 138₂, . . . 138_{M-1}). However, since some inputs and internal states are repeated for multiple times, this overhead can be logically optimized in order to consume fewer XOR gates with smaller dimensionality. In this case, dimensionality refers to the number of inputs of XOR gates.

A hardware overhead comparison is summarized in Table 1.

TABLE 1
Hardware overhead comparison between MISR, SISR
and pre-computed SISR Conditioning Components.

| Circuit | XOR gates | Flip-Flops | Health tests |
|---|---|---|---|
| SISR | M × (K + 1) | M × N | M × H |
| MISR | M + K | M | M × H |
| SISR with pre- | maximum | M | N × H |
| computing | M × (K + 1) | | |

As seen in the comparison, the MISR circuit provides the best hardware overhead (excluding health tests). As shown in Table 1, MISR (row 2) requires less XOR gates and flip-flops then SISR (row 1) and SISR with pre-computing circuit (row 3), while MISR requires more inputs, which leads to increasing the number of Health Tests. However, since a pre-computed circuit requires N<M health test blocks, it requires much less area to be implemented. Since all the circuits produce M random bits within one clock cycle, there is no difference in performance overhead. In terms of statistical characteristics (entropy) of the generated sequence, a pre-computed SISR outperforms SISR and MISR.

Thus, the conditioning components in this invention can provide higher quality with a significant reduction in hardware even with health test hardware.

Pre-computed SISR. Consider an example of a 4-bit SISR circuit with 2 input bits do and d1 which is pre-computed for 4 rounds. The SISR has a feedback polynomial φ(Q)=q_3⊕q_2⊕1 and initial states of flip-flops q0(0), q1(0), q2(0), q3(0). As a result, initial feedback bit can be computed as follows f0=q2(0)⊕q3(0)⊕d0.

Thus, after the first round the internal states, q0(1), q1(1), q2(1), q3(1) and feedback bit f1 can be computed as follows.

$$\\ \begin{matrix}\begin{matrix}{q}_{0}^{{}_{} ( 1 )} = {f}_{0} = {q}_{2}^{{}_{} ( 0 )} ⊕ {q}_{3}^{{}_{} ( 0 )} ⊕ {d}_{0}^{{}_{} ( 0 )} , \\ {q}_{1}^{{}_{} ( 1 )} = {q}_{0}^{{}_{} ( 0 )} , \\ {q}_{2}^{{}_{} ( 1 )} = {q}_{1}^{{}_{} ( 0 )} , \\ \\ {q}_{3}^{{}_{} ( 1 )} = {q}_{2}^{{}_{} ( 0 )} , \\ {f}_{1} = {q}_{2}^{{}_{} ( 1 )} ⊕ {q}_{3}^{{}_{} ( 1 )} ⊕ {d}_{1}^{{}_{} ( 1 )} = {q}_{1}^{{}_{} ( 0 )} ⊕ {q}_{2}^{{}_{} ( 0 )} ⊕ {d}_{1}^{{}_{} ( 1 )} .\end{matrix} & ( 5 )\end{matrix}$$

Similarly, after the second round of computations, the results are:

$$\\ \begin{matrix}\begin{matrix}{q}_{0}^{{}_{} ( 2 )} = {f}_{1} = {q}_{1}^{{}_{} ( 0 )} ⊕ {q}_{2}^{{}_{} ( 0 )} ⊕ {d}_{1}^{{}_{} ( 1 )} , \\ {q}_{1}^{{}_{} ( 2 )} = {q}_{0}^{{}_{} ( 1 )} = {q}_{2}^{{}_{} ( 0 )} ⊕ {q}_{3}^{{}_{} ( 0 )} ⊕ {d}_{0}^{{}_{} ( 0 )} , \\ {q}_{2}^{{}_{} ( 2 )} = {q}_{1}^{{}_{} ( 1 )} = {q}_{0}^{{}_{} ( 0 )} , \\ \\ {q}_{3}^{{}_{} ( 2 )} = {q}_{2}^{{}_{} ( 1 )} = {q}_{1}^{{}_{} ( 0 )} , \\ {f}_{2} = {q}_{2}^{{}_{} ( 2 )} ⊕ {q}_{3}^{{}_{} ( 2 )} ⊕ {d}_{0}^{{}_{} ( 2 )} = {q}_{0}^{{}_{} ( 0 )} ⊕ {q}_{1}^{{}_{} ( 0 )} ⊕ {d}_{0}^{{}_{} ( 2 )} .\end{matrix} & ( 6 )\end{matrix}$$

A third round utilizes the following equations:

$$\\ \begin{matrix}\begin{matrix}{q}_{0}^{{}_{} ( 3 )} = {f}_{2} = {q}_{0}^{{}_{} ( 0 )} ⊕ {q}_{1}^{{}_{} ( 0 )} ⊕ {d}_{0}^{{}_{} ( 2 )} , \\ {q}_{1}^{{}_{} ( 3 )} = {q}_{0}^{{}_{} ( 2 )} = {q}_{1}^{{}_{} ( 0 )} ⊕ {q}_{2}^{{}_{} ( 0 )} ⊕ {d}_{1}^{{}_{} ( 1 )} , \\ {q}_{2}^{{}_{} ( 3 )} = {q}_{1}^{{}_{} ( 2 )} = {q}_{2}^{{}_{} ( 0 )} ⊕ {q}_{3}^{{}_{} ( 0 )} ⊕ {d}_{0}^{{}_{} ( 0 )} , \\ \\ {q}_{3}^{{}_{} ( 3 )} = {q}_{2}^{{}_{} ( 2 )} = {q}_{0}^{{}_{} ( 0 )} , \\ {f}_{3} = {q}_{2}^{{}_{} ( 3 )} ⊕ {q}_{3}^{{}_{} ( 3 )} ⊕ {d}_{1}^{{}_{} ( 3 )} = {q}_{2}^{{}_{} ( 0 )} ⊕ {q}_{3}^{{}_{} ( 0 )} ⊕ {d}_{0}^{{}_{} ( 0 )} ⊕ {q}_{0}^{{}_{} ( 0 )} ⊕ {d}_{1}^{{}_{} ( 3 )} = {q}_{0}^{{}_{} ( 0 )} ⊕ {q}_{2}^{{}_{} ( 0 )} ⊕ {q}_{3}^{{}_{} ( 0 )} ⊕ {d}_{0}^{{}_{} ( 0 )} ⊕ {d}_{1}^{{}_{} ( 3 )} .\end{matrix} & ( 7 )\end{matrix}$$

Final states of SISR can be computed in the following way:

$$\\ \begin{matrix}{q}_{0}^{{}_{} ( 4 )} = {f}_{3} = {q}_{0}^{{}_{} ( 0 )} ⊕ {q}_{2}^{{}_{} ( 0 )} ⊕ {q}_{3}^{{}_{} ( 0 )} ⊕ {d}_{0}^{{}_{} ( 0 )} ⊕ {d}_{1}^{{}_{} ( 3 )} \\ {q}_{1}^{{}_{} ( 4 )} = {q}_{0}^{{}_{} ( 3 )} = {q}_{0}^{{}_{} ( 0 )} ⊕ {q}_{1}^{{}_{} ( 0 )} ⊕ {d}_{0}^{{}_{} ( 2 )} \\ {q}_{2}^{{}_{} ( 4 )} = {q}_{1}^{{}_{} ( 3 )} = {q}_{1}^{{}_{} ( 0 )} ⊕ {q}_{2}^{{}_{} ( 0 )} ⊕ {d}_{1}^{{}_{} ( 1 )} \\ {q}_{3}^{{}_{} ( 4 )} = {q}_{2}^{{}_{} ( 3 )} = {q}_{2}^{{}_{} ( 0 )} ⊕ {q}_{3}^{{}_{} ( 0 )} ⊕ {d}_{0}^{{}_{} ( 0 )}\end{matrix}$$

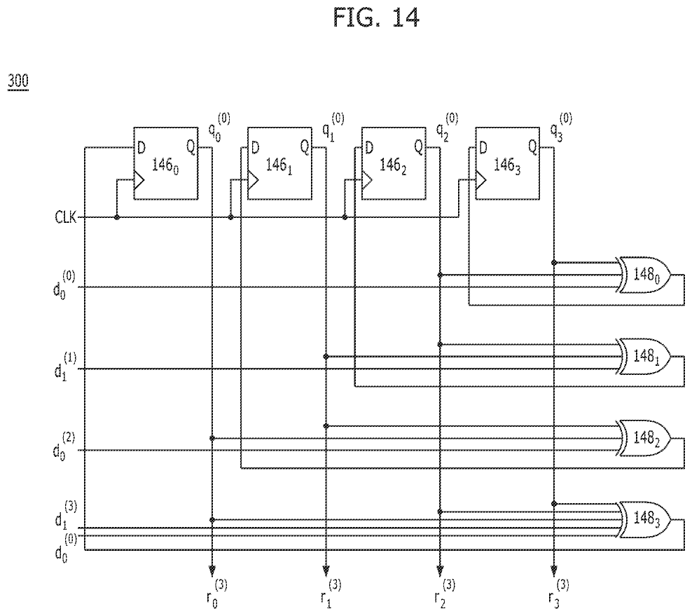

This pre-computing circuit 300 can be implemented as shown in FIG. 14 with flip flop 146₀, 146₁, . . . 146₃ and with multiple input exclusive OR gates 148₀, 148₁, . . . 148₃. The inputs and operation of pre-computing circuit 300 is based on the principles as in pre-computing circuit 200 in FIG. 13 and all intermediate stages are omitted here.

Experimental results. An entropy source producing true random numbers with an entropy value of 0.694719 was tested with the three following conditioning components

$$\\ \begin{matrix}1. 128 ‐ bit MISR with φ ( Q ) = {q}_{127} ⊕ {q}_{28} ⊕ {q}_{26} ⊕ {q}_{1} ⊕ 1 polynomial \\ 2. 128 \; 8 ‐ bit SISRs with φ ( Q ) = {q}_{7} ⊕ {q}_{5} ⊕ {q}_{4} ⊕ {q}_{3} ⊕ 1 polynomials \\ 3. 128 ‐ bit pre ‐ computed SISR with φ ( Q ) = {q}_{127} ⊕ {q}_{28} ⊕ {q}_{26} ⊕ {q}_{1} ⊕ 1 polynomial .\end{matrix}$$

In the first two cases, there were 128 entropy sources. In the third case, there were only 8 entropy sources. The experimental results are summarized in Table 2. The entropy sources and the conditioning components were implemented in Xilinx Artix-7 FPGA. (See www.xilinx.com/products/silicon-devices/fpga/artix-7.html).

Table 2 shows a comparison of hardware overhead and entropy values for conditioning components (where LUTs are the number of logic units such as the XOR comparators and FFs are the number of flip flops).

TABLE 2

| Conditioning | Circuit | | Health Tests | | Total | | |
|---|---|---|---|---|---|---|---|
| Component | LUTs | FFs | LUTs | FFs | LUTs | FFs | Entropy |
| MISR | 128 | 128 | 7808 | 5248 | 7936 | 5376 | 0.874065 |
| SISR | 256 | 1024 | 7808 | 5248 | 8064 | 6272 | 0.894603 |
| SISR with | 335 | 128 | 488 | 328 | 823 | 456 | 0.940820 |
| pre- | | | | | | | |
| computing | | | | | | | |

As shown in Table 2, the inventive conditioning component saves more than 90% of hardware resources and provides 5-7% better entropy compared to standard conditioning components.

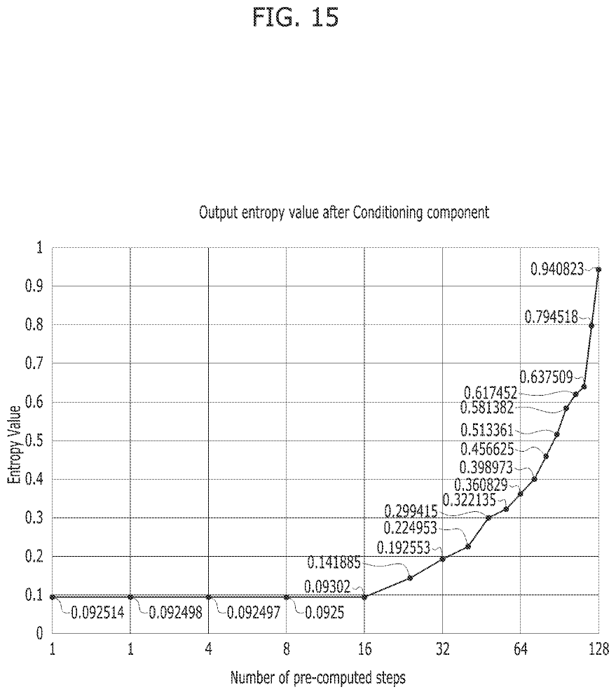

One important parameter of the inventive conditioning component is the number of precomputed steps. FIG. 15 shows the dependency between the number of pre-computed steps and entropy value.

As shown in FIG. 15, the number of precomputed steps should be much larger than N (in this case N=8). However, this result can be tuned in order to save hardware resources, i.e., take a smaller number of steps to save on the number of LUT blocks while still achieving lower entropy values (e.g., if M=104, entropy value is 0.617452 and number of used LUT blocks is 270).

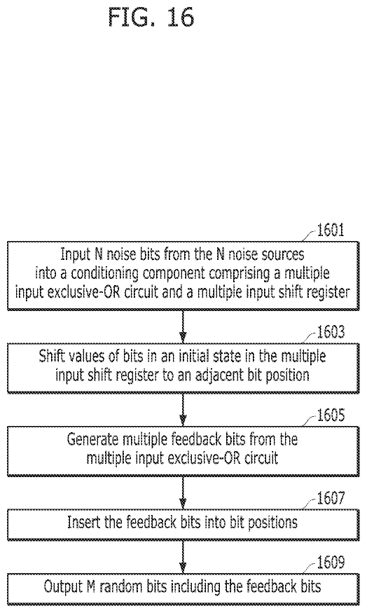

FIG. 16 is a flowchart illustrating a method for generating a random number sequence. The method at 1601 inputs N noise bits from N noise sources into a conditioning component comprising a multiple input exclusive-OR circuit and a multiple input shift register. At 1603, the method shifts values of bits in an initial state in the multiple input shift register to an adjacent bit position. At 1605, the method generates multiple feedback bits from the multiple input exclusive-OR circuit. At 1607, the method inserts the feedback bits into specified bit positions. At 1609, the method outputs M random bits including the feedback bits.

The method of FIG. 16 may (in order to generate the feedback bit f) XOR a) at least one internal state bit in the multiple input shift register with b) an input noise bit of the N noise bits. The internal state bit may be derived from a feedback polynomial such as in equation (1) (noted above).

$$\\ \begin{matrix}φ ( Q ) = {⊕}_{i = 0}^{L - 1} {α}_{i} \cdot {q}_{i} + 1 & ( 1 )\end{matrix}$$

where αᵢ is a polynomial coefficient which can be either 0 or 1.

The method of FIG. 16 may shift the values of the bits in the multiple input shift register by one position right in order to add the feedback bit to a start of the output M bits such as for example {f, q0(t), q1(t), . . . , qL−2(t)}, where q represents the stored values for example in flip flops of the multiple input shift register. The multiple input shift register may comprise a set of flip flops. The multiple input exclusive-OR circuit may comprise a set of multiple input exclusive-OR gates, with each of the multiple input exclusive-OR gates receiving different noise bits and producing respective feedback bits.

The method of FIG. 16 may provide respective feedback bits to respective flip flops in the multiple input shift register. This method may output the M bits from the respective flip flops in the multiple input shift register. This method may precompute the feedback bits from the set of multiple input exclusive-OR gates prior to outputting the M bits. This method may output from the conditioning component, for the M bits, a sequence of random bits r0, r1, . . . rM−1.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives recognized by one skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, or a combination of one or more of them. Apparatus, devices, and machines for processing data in the invention can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. The computer program can be embodied as a computer program product as noted above containing a computer readable medium.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

What is claimed is:

1. A random number generator comprising:
a noise source configured to generate N sources of N noise bits; and
a conditioning component comprising a multiple input exclusive-OR circuit generating feedback bits and a multiple input shift register receiving the feedback bits, wherein
the conditioning component is configured to process a sequence of the N noise bits from the N noise sources and output M random bits including the feedback bits.

2. The generator of claim 1, wherein the multiple input exclusive-OR circuit is configured to generate the feedback bits based on XORing a) at least one internal state bit with b) an input noise bit of the N noise bits.

3. The generator of claim 2, wherein the internal state bits are derived from a feedback polynomial.

4. The generator of claim 1, wherein the multiple input shift register is configured to shift data bits therein by one position right in order to add the feedback bit to a start of the output M bits.

5. The generator of claim 1, wherein the multiple input shift register comprising a set of flip flops.

6. The generator of claim 5, wherein the multiple input exclusive-OR circuit comprises a set of multiple input exclusive-OR gates, with each of the multiple input exclusive-OR gates receiving a different noise bits and producing respective feedback bits.

7. The generator of claim 6, wherein the respective feedback bits are provided to respective flip flops in the multiple input shift register.

8. The generator of claim 7, wherein the respective flip flops in the multiple input shift register output the M bits.

9. The generator of claim 6, wherein the set of multiple input exclusive-OR gates are configured to provide precomputation of the feedback bits prior to outputting the M bits.

10. The generator of claim 1, wherein the conditioning component is configured to:
output for the M bits a sequence of random bits r0, r1, . . . rM−1.

11. A method for generating random numbers from N noise sources, comprising:
inputting N noise bits from the N noise sources into a conditioning component comprising a multiple input exclusive-OR circuit and a multiple input shift register;
shifting values of bits in an initial state in the multiple input shift register to an adjacent bit position;
generating feedback bits from the multiple input exclusive-OR circuit;
inserting the feedback bits into bit positions; and
outputting M random bits including the feedback bits.

12. The method of claim 11, wherein the generating the feedback bits comprises XORing a) at least one internal state bit in the multiple input shift register with b) an input noise bit of the N noise bits.

13. The method of claim 12, wherein the internal state bits are derived from a feedback polynomial.

14. The method of claim 11, further comprising shifting the values of the bits in the multiple input shift register by one position right in order to add the feedback bit to a start of the output M bits.

15. The method of claim 11, wherein the multiple input shift register comprising a set of flip flops.

16. The method of claim 15, wherein the multiple input exclusive-OR circuit comprises a set of multiple input exclusive-OR gates, with each of the multiple input exclusive-OR gates receiving a different noise bit and producing respective feedback bits.

17. The method of claim 16, providing the respective feedback bits to respective flip flops in the multiple input shift register.

18. The method of claim 17, further comprising outputting the M bits from the respective flip flops in the multiple input shift register.

19. The method of claim 16, further comprising precomputing the feedback bits from the set of multiple input exclusive-OR gates prior to outputting the M bits.

20. The method of claim 11, further comprising outputting from the conditioning component, for the M bits, a sequence of random bits r0, r1, . . . rM−1.
